(19) United States
(12) Patent Application Publication
(10) Pub. No.: US 2009/0184005 A1
(43) Pub. Date: Jul. 23, 2009

(54) Sensor for Measurement of Hydrogen Sulfide

(76) Inventors: Xueji Zhang, Sarasota, FL (US); David Kraus, Birmingham, AL (US)

Correspondence Address: ALIX YALE & RISTAS LLP, 750 MAIN STREET, SUITE 1400, HARTFORD, CT, 06103, US

(21) Appl. No.: 11/577,731

(22) PCT Filed: Oct. 12, 2005
(86) PCT No.: PCT/US05/36526

§ 371 Date: Feb. 23, 2009

Related U.S. Application Data
(60) Provisional application No. 60/621,848, filed on Oct. 25, 2004.

(51) Int. Cl. G01N 27/26

(52) U.S. Cl. 205/786.5; 204/415

(57) ABSTRACT

An electrochemical sensor for measurement of hydrogen sulfide is described. The electrochemical sensor comprises an electrolyte; an electrolyte container comprising a hydrogen sulfide permeable membrane; a working electrode and a reference electrode both disposed in the electrolyte; and an instrument capable of maintaining a fixed DC potential in the range of 0 mV to 1,000 mV between the working electrode and the reference electrode. Also a method of detecting hydrogen sulfide in a sample. The method comprises providing an electrochemical sensor; at least partially immersing the gas permeable membrane in the sample; and detecting hydrogen sulfide in the sample. The detection may be qualitative or quantitative.

### FIELD OF THE INVENTION

The present invention relates to an electrochemical sensor suitable for measurement and detection of dissolved hydrogen sulfide in aqueous solutions, especially in biomedical media at low nanomolar concentrations.

### BACKGROUND OF THE INVENTION

Sulfide can exist in three states in an aqueous environment: (1) dissolved hydrogen sulfide (dissolved H₂S); (2) HS⁻; and (3) S²⁻. Hydrogen sulfide (H₂S) is usually known as a toxic gas having the smell of rotten eggs. Hydrogen sulfide can be formed by sulphate reduction or decomposition of sulphur-containing organic substances in water having low oxygen content. Hydrogen sulfide can be highly toxic and may present a major health concern to those who handle sulfide-containing product. Thus, it is very important to detect hydrogen sulfide in both gaseous and dissolved forms.

Recently, several reports have been published indicating that hydrogen sulfide is produced endogenously from the amino acids L-cystein and homocystein by cystathionine—B-synthetase (CBS) in human, bovine and rat brains. Hydrogen sulfide may act similar to nitric oxide and carbon monoxide and may act as a neurotransmitter in biological systems.

There are many reported methods to measure hydrogen sulfide in the gas phase, however there are few reported methods for measuring hydrogen sulfide dissolved in aqueous media and no reported method for measuring hydrogen sulfide in biological media. Thus, there is a need for a method and apparatus to detect hydrogen sulfide dissolved in an aqueous phase or in biological media.

### SUMMARY OF THE INVENTION

Briefly, one aspect of the invention provides an electrochemical sensor for measurement of hydrogen sulfide. The electrochemical sensor comprises an electrolyte; an electrolyte container comprising a hydrogen sulfide permeable membrane; a working electrode and a reference electrode both disposed in the electrolyte; and an instrument capable of maintaining a fixed DC potential of 0 mV to 1,000 mV between the working electrode and the reference electrode.

Advantageously, the gas permeable membrane is silicon polycarbonate. The working electrode will comprise a noble metal. The reference electrode will comprise a noble metal and a noble metal oxide. The preferred electrolyte comprises a sodium carbonate buffer solution having a pH of 9 to 13, propylene carbonate and potassium ferricyanide.

Another aspect of the invention provides a preferred method of measuring dissolved hydrogen sulfide in a sample. The nature of samples compatible with the method include gaseous, air, water, aqueous solutions and solutions comprising biological media. The method may be applicable to in vitro use. The method comprises providing a sensor comprising a silicon polycarbonate gas permeable membrane, a working electrode and a reference electrode immersed in an electrolyte; maintaining a fixed DC potential of 0 mV to 1,000 mV between the working electrode and the reference electrode; at least partially immersing the gas permeable membrane in a sample; and qualitatively or quantitatively measuring the amount of hydrogen sulfide in the sample.

In general, the material of the invention may be alternately formulated to comprise, consist of, or consist essentially of, any appropriate components herein disclosed. The material of the invention may additionally, or alternatively, be formulated so as to be devoid, or substantially free, of any components, materials, ingredients, adjuvants or species used in the prior art compositions or that are otherwise not necessary to the achievement of the function and/or objectives of the present invention.

When the word “about” is used herein it is meant that the amount or condition it modifies can vary some beyond that so long as the advantages of the invention are realized. Practically, there is rarely the time or resources available to very precisely determine the limits of all the parameters of ones invention because to do would require an effort far greater than can be justified at the time the invention is being developed to a commercial reality. The skilled artisan understands this and expects that the disclosed results of the invention might extend, at least somewhat, beyond one or more of the limits disclosed. Later, having the benefit of the inventors disclosure and understanding the inventive concept and embodiments disclosed including the best mode known to the inventor, the inventor and others can, without inventive effort, explore beyond the limits disclosed to determine if the invention is realized beyond those limits and, when embodiments are found to be without any unexpected characteristics, those embodiments are within the meaning of the term about as used herein. It is not difficult for the artisan or others to determine whether such an embodiment is either as expected or, because of either a break in the continuity of results or one or more features that are significantly better than reported by the inventor, is surprising and thus an unobvious teaching leading to a further advance in the art.

As used herein the transitional phrase “consisting essentially of” limits the scope of the claim to the specified materials or steps “and those that do not materially affect the basic and novel characteristic(s)” of the claimed invention.

As used herein the transitional phrase “consisting of” limits the scope of the claim to only the specified materials or steps.

A better understanding of the invention will be obtained from the following detailed description of the presently preferred, albeit illustrative, embodiments of the invention.

### BRIEF DESCRIPTION OF THE DRAWINGS

Other objects and advantages of the invention will be evident to one of ordinary skill in the art from the following detailed description made with reference to the accompanying drawings, in which:

FIG. 1 is a perspective illustration, partially exploded, of one embodiment of an electrochemical sensor for detection of hydrogen sulfide dissolved in a sample.

FIG. 2 is a cross-sectional view of one embodiment of a combination working and reference electrode for use in an electrochemical sensor for detection of hydrogen sulfide dissolved in a sample.

FIG. 3 is a schematic illustration of one embodiment of a dissolved hydrogen sulfide detection apparatus including an electrochemical sensor in a sample.

FIG. 4A is a graph illustrating response of the electrochemical sensor to calibration solutions. NO (left curve), H₂S (right curve) and O₂ (constant line) concentrations provided from different sensors are also shown. FIG. 4B is a graph illustrating response of the electrochemical sensor to a separate calibration than used in FIG. 4A.

FIG. 5A illustrates use of the electrochemical sensor to obtain real-time concentrations of H₂S (lower trace) in a closed chamber containing a solution comprising mitochondria isolated from marine mussel gills. The upper trace is O₂ concentration from a different sensor. FIG. 5B illustrates derivatives (H₂S as lower trace and O₂ as upper trace) of the traces in FIG. 5A.

FIG. 6 illustrates use of the electrochemical sensor to obtain real time measurement of H₂S production in solutions of rat aorta homogenate (Aorta homogenate), cultured rat vascular smooth muscle cells (VSMC) and living rat tail artery (Intact Tail Artery).

FIG. 7 illustrates use of the electrochemical sensor to measure H₂S concentration (lower trace) of a physiological saline solution in which segments of isolated rat aorta are held under tension. The upper trace is aorta tension from a different sensor.

### DETAILED DESCRIPTION

The unique features of this invention are set forth in the appended claims. The invention itself, however, both as to its construction and its method of operation, will be best understood from the following description.

The principal chemical reaction of this invention is outlined in scheme 1, which illustrates how ferrocyanide ([Fe(CN)₆]⁴⁻) is first oxidized to ferricyanide ([Fe(CN)₆]³⁻) at the surface of an electrode in a sample. The ferricyanide then undergoes a catalytic reduction by sulfide ions restoring the ferrocyanide state. The reduced ferrocyanide is subsequently electrochemically oxidized to ferricyanide at the working electrode.

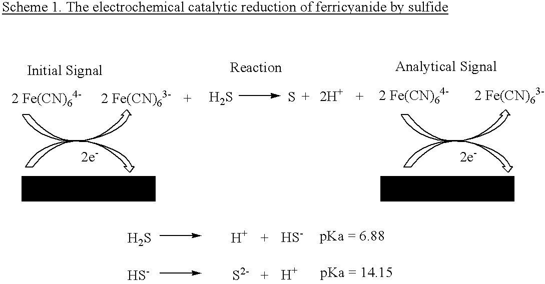

The amount of current used to electrochemically oxidize the reduced ferrocyanide to ferricyanide is a measure of the sample's hydrogen sulfide concentration. Thus, an electronic signal can be generated to provide a qualitative or quantitative measure of the dissolved hydrogen sulfide concentration in a sample. The electrochemical oxidation is not disturbed by elementary sulphur.

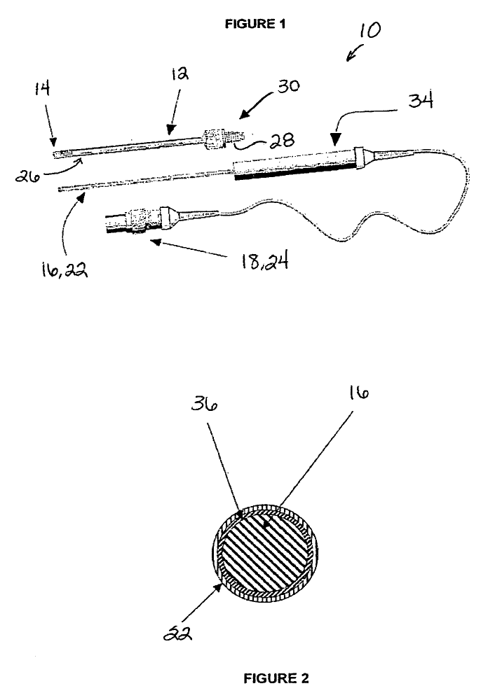

FIG. 1 illustrates one embodiment of a hydrogen sulfide sensor 10 comprising a sleeve 12, a hydrogen permeable membrane 14, a working electrode 16 having an electrical connection 18 extending therefrom and a reference electrode 22 having an electrical connection 24 extending therefrom.

The sleeve 12 is fluid impermeable and is advantageously made of stainless steel or other non-contaminating material. The thin, hydrogen sulfide permeable membrane 14 is attached to the sleeve 12, advantageously at, or adjacent to, a tip end 26 of the sleeve 12. While the entire sleeve may be made from the material of the gas permeable membrane material, such a sleeve is not believed to be economically beneficial. Advantageously, a connector 28 is disposed adjacent to a connecting end 30 of the sleeve 12 opposing the tip end 26. The connector 28 is selectively engagable with a probe handle 34 using any well known connection method such as threads, interference fit, bayonet mounting, etc. The sleeve may also be permanently mounted to, or integral with, the probe handle.

A suitable material for making the hydrogen sulfide permeable membrane 14 is silicon polycarbonate having a thickness of about 10 microns to about 50 microns. One preferred hydrogen sulfide permeable membrane is IHL-1040 available from World Precision Instruments, 175 Sarasota Center Blvd., Sarasota, Fla., 34240.

The working electrode 16 is comprised of a noble metal. Noble metals include platinum, palladium, iridium, rhodium, ruthenium and osmium. Mercury, gold and silver are not suitable for use as working electrode materials due to reaction of those noble metals with sulfur. Currently platinum is preferred for use as a working electrode 16. It might also be possible to use a less noble substrate coated with a noble metal as a working electrode 16. It is believed that noble metal coatings could be applied by any known method, for example plating, sputtering, painting, etc. The working electrode 16 may be in the form of a solid wire. The working electrode 16 has an electrical connection 18 extending therefrom.

The reference electrode 22 comprises a noble metal/noble metal oxide combination, for example, platinum/platinum oxide or palladium/palladium oxide. The reference electrode 22 may be in the form of a noble metal/noble metal oxide coating on a substrate. The noble metal/noble metal oxide coating can be prepared by, for example, plating, sputtering, painting, etc. the noble metal/noble metal oxide coating onto a substrate. Naturally, the process conditions would be controlled to provide a coating comprising both the noble metal and the noble metal oxide. Mercury, gold and silver are not suitable for use as reference electrode materials due to reaction of those noble metals with sulfur. Non-noble metal/non-noble metal oxide combinations are not stable and can not hold a stable potential as reference electrode. The reference electrode 22 has an electrical connection 24 extending therefrom.

In use, the working 16 and reference 22 electrodes are electrically separated. The working electrode and reference electrode are advantageously physically combined or integrated as shown in FIG. 2 with an insulative layer 36 disposed between the electrodes 16, 22. Nonconductive polymeric materials can be used to form the insulative layer 36.

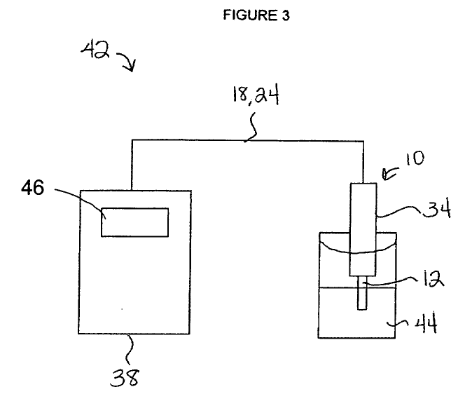

With reference to FIG. 3, the working electrode 16 and reference electrode 22 are disposed in an alkaline electrolyte mixture in the sleeve 12 to provide the sensor 10. The working electrode electrical connection 18 and reference electrode electrical connection 24 are electrically connected to a device 38 that will maintain a fixed potential between the working 16 and reference 22 electrodes to provide a dissolved hydrogen sulfide detection apparatus 42. The device can comprise a display 46 that can be correlated with the signal provided by the sensor 10 to provide an indication of the presence and/or amount of H₂S in a sample.

When the sensor 16 is placed in a sample 44, hydrogen sulfide can diffuse through the thin, silicon polycarbonate membrane 14 into the inert electrolyte mixture. In the electrolyte mixture the hydrogen sulfide dissociates into H⁺+HS⁻(equation 1). The HS⁻ is oxidized by ferricyanide ([Fe(CN)₆]³⁻) to form ferrocyanide ([Fe(CN)₆]⁴⁻)+S+H⁺ (equation 2). Finally ferrocyanide is electrochemically reoxidized back to ferricyanide (equation 3).

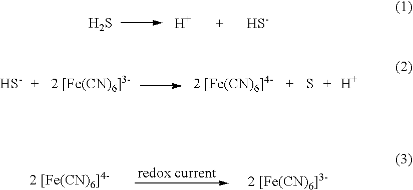

The redox current imposed by the device 38 to convert ferrocyanide to ferricyanide is proportional to the hydrogen sulfide concentration. Thus, a signal can be generated by the redox current that provides a quantitative indication of the dissolved hydrogen sulfide concentration in a sample. The electrochemical oxidation is not disturbed by elementary sulfur.

It should be understood that the following examples are included for purposes of illustration so that the invention may be more readily understood and are in no way intended to limit the scope of the invention.

One embodiment of a combination working and reference electrode can be prepared as follows.

A 1 mm diameter platinum wire is cut to a length of about 5 mm. One end of the cut platinum wire is tapered. A hole 0.5 mm in diameter is drilled axially into the platinum wire from the tapered end to a depth of about 2 mm.

A 15 cm length of insulated solid copper 28 gauge wire is provided. About 2 mm of insulation is removed from one end of the copper wire and about 1.2 mm of insulation is removed from the opposing end of the copper wire. The 2 mm stripped end of the copper wire is disposed within the platinum wire hole and the wire is electrically attached thereto by, for example, soldering to form a lead with a platinum tip and a free end. The platinum tip is cleaned to remove any rough edges.

The platinum tip is rinsed in denatured alcohol. After rinsing, the lead is dipped into an epoxy mixture from the platinum tip up to about 2.5 mm beyond the platinum/wire electrical connection. One advantageous silicone based epoxy suitable for this use is 1-2620 dispersion available from Dow Corning. Excess epoxy is removed from the platinum tip by, for example, gently wiping with a paper tissue. The epoxy coated lead is dried in room temperature air for about 10 min and subsequently cured in an oven set at about 85° C. for about 15 minutes.

The entire of length of the assembled lead is covered with heat shrinkable tubing. The tubing is heated to shrink, encapsulate and electrically insulate the lead. The platinum tip should be sealed by the shrunken tubing and no holes should be present.

A noble metal/noble metal oxide coating is applied from the platinum tip to about 8 mm beyond the platinum tip. One advantageous material for this coating is a paint comprising platinum and platinum particles or nanoparticles in an adhesive binder. This platinum/platinum oxide paint is available as Pt/PtOx paint from World Precision Instruments. The platinum/platinum oxide paint is allowed to cure. After the platinum/platinum oxide paint has cured an electrically conductive coating is applied from the platinum tip to about 10 cm beyond the platinum tip. One advantageous material for this coating is a conductive, silver filled paint called “silver epoxy” and available from World Precision Instruments. After coating, the coated lead can be heated in an oven set at about 100° C. for about 20 minutes to cure.

An 11 cm length of heat shrink tubing (about 2 mm id) is disposed over the coated lead. The end of the heat shrink tubing is displaced away from the platinum tip end of the lead so that about 4 mm of the metal/metal oxide coated platinum tip end is exposed.

A 6 cm length of insulated 28 gauge solid copper wire is provided. About 5 mm of insulation is removed from one end of the copper wire and about 1.5 cm of insulation is removed from the opposing end of the copper wire. The insulated copper wire is placed inside the heat shrink tubing so that the 5 mm of bare copper wire makes physical and electrical contact with the conductive metal coating. The opposing reference electrode free end projects from the tubing. The tubing is heated to shrink and encapsulate the lead and copper wire and form the combination electrode.

The platinum tip portion of the lead is polished to expose the platinum tip and provide a flat, smooth surface. Polishing with 600 grit media followed by a polishing film layered paper available from Fisher Scientific has been found adequate. At least 3 mm of the coated platinum tip should remain after polishing. Polishing is complete when the platinum tip attains a mirror finish.

A 120 cm length of 30 gauge, insulated, multiconductor electrical cable is provided. 2.5 mm of insulation is stripped from one end of each of the conductors. One conductor is electrically attached to the working electrode free end. Another conductor is electrically attached to the reference electrode free end. The free ends of the multiconductor electrical cable are electrically and physically attached to an electrical connection. The resulting combination electrode with probe handle and electrical connection is shown in FIG. 1.

The sleeve is filled with an electrolyte mixture comprising ferricyanide in an alkaline solution. The pH range of the mixture may range from about 9 to about 13, advantageously from about 10 to about 11 and preferably about 10. The mixture may comprise a sodium carbonate buffer solution and propylene carbonate. One suitable electrolyte mixture is prepared as follows. Prepare pH 10, 0.1 M sodium carbonate buffer solution. Propylene carbonate is added to achieve a final concentration of 1% propylene carbonate in the buffer solution. Potassium Ferrocyanide is added to achieve a final concentration of 0.05 M Potassium Ferrocyanide in the buffer/propylene carbonate solution.

The combination electrode is disposed in the sleeve and the connector is attached to the probe handle to form the hydrogen sulfide sensor. The probe electrical connection is electrically connected to a device that will maintain a fixed potential between the working and reference electrodes. The device will maintain a fixed potential of 0 mV to 1,000 mV, advantageously 100 mV to 500 mV and preferably about 160 mV, between the working and reference electrodes. An Apollo 4000 Free Radical Analyzer available from World Precision Instruments has been found suitable for maintaining a fixed potential between the working and reference electrodes.

### General:

The Apollo 4000 Free Radical Analyzer available from World Precision Instruments was used in combination with the electrochemical H₂S sensor in EXAMPLES 1-4.

### EXAMPLE 1

Solutions used in EXAMPLE 1 were based on aqueous physiological saline solution, which is 150 mM NaCl with 10 mM potassium phosphate buffer (PBS) pH 7.35 at 37° C. The physiological saline solution also contained 50 μM diethylenetriaminepentaacetate (DTPA) to chelate trace metals and limit spontaneous H2S oxidation.

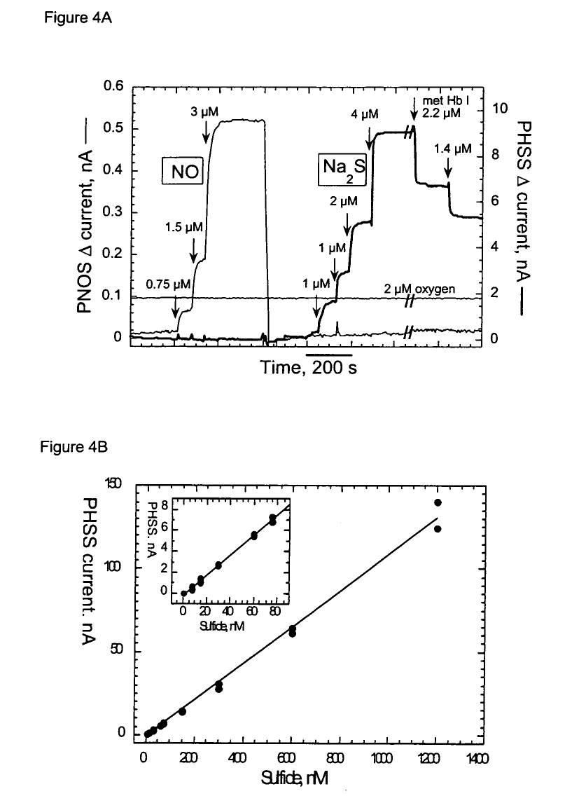

With reference to FIG. 4A, the calibration of the electrochemical H₂S sensor (PHSS) occurred in a chamber also containing NO (PNOS) and O2 (POS) sensors. NO (leftmost curve) and O₂ (constant line) concentrations were measured simultaneously with the H₂S (right curve) concentration. The O2 concentration in the sample was stable at 2 μM. NO was added first to show that the response of the NO (PNOS) sensor was independent of response of the H₂S (PHSS) and O₂ (POS) sensors. NO was then removed from the chamber by flushing with 2 μM O₂-equibrated buffer. H₂S was then added as Na₂S, which rapidly becomes H₂S and HS— at physiological pH. After Na₂S was added in stepwise fashion to increase H₂S concentrations, a H₂S scavenging hemoglobin, metHb I, was added to remove a portion of the H₂S in the chamber. The calibration curve in FIG. 4B was from a separate calibration performed under similar conditions.

With reference to FIG. 4A, the electrochemical H₂S sensor (PHSS), as part of the hydrogen sulfide detection apparatus, is specific for H₂S as shown in the calibration trace. There is no evidence that the PHSS is reactive to either NO or O₂ and the ISO-NOP sensor and oxygen sensor are likewise unresponsive to H₂S. The H2S sensor (PHSS) response is equally rapid to increasing H₂S concentration and to decreasing H₂S concentration. As shown in FIG. 4B the PHSS provides a detection limit down to 10 nanomolar.

### EXAMPLE 2

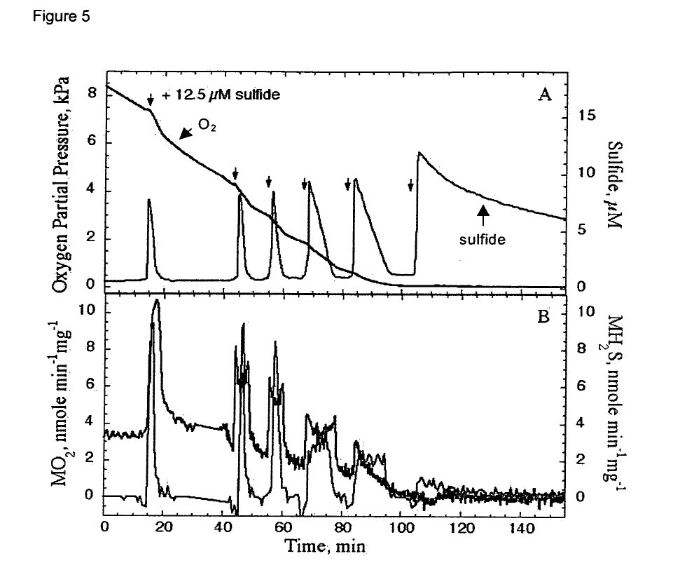

The cellular organelle responsible for O₂ consumption in biological cells is the mitochondrion. Mitochondria isolated from the gills of a marine mussel which lives in marine sediments containing high concentrations of H₂S exhibit an ability to rapidly consume H₂S, which also stimulates O₂ consumption. Such rapid kinetic events could not be adequately followed with standard colorimetric methods for H₂S determination. However, as shown in FIG. 5, the hydrogen sulfide detection apparatus comprising the PHSS reports the H₂S concentration in solution continuously allowing for highly detailed analysis of these rapid kinetic events.

Mitochondria were isolated using the isolation procedure referenced in Parrino, V., D. W. Kraus and J. E. Doeller; ATP production from the oxidation of sulfide in gill mitochondria of the ribbed mussel Geukensia demissa; J. Exp. Biol.; (2000) 203:2209-2218, the contents of which are incorporated by reference herein. The mitochondria were suspended in an aqueous salt- and sucrose-containing buffer described in the Parrino reference.

In FIG. 5A two traces show the real-time concentrations of H₂S and O₂ in a closed chamber containing a mitochondria suspension isolated from mussel gills. The lower trace is H₂S concentration and the upper trace is O₂ concentration from a different sensor. Injections of 12.5 μM sulfide (Na₂S, indicated by arrows) each stimulate O₂ consumption until the sulfide is consumed. As the chamber O₂ is exhausted the sulfide is consumed much more slowly. In FIG. 5B the derivatives (H₂S as lower trace and O₂ as upper trace) of the traces in FIG. 5A are shown. The detail provided by the hydrogen sulfide detection apparatus comprising the PHSS shows complex multi-phasic kinetic events that would be impossible to resolve with any other method of H₂S determination.

### EXAMPLE 3

Recently it has been proposed that H₂S is produced endogenously in mammalian tissues and serves as a critical cell signaling molecule. In earlier reports H₂S production was demonstrated as single point measurements only with homogenized tissue and typically the biological sample was exposed to very acidic pH during these measurement. The hydrogen sulfide detection apparatus comprising the PHSS can be used in solutions having near neutral pH similar to body fluids.

In general, the following biological samples are bathed in the potassium phosphate buffer (PBS) described above. The specific procedures are found in Doeller, J. E., Isbell, T. S., Benavides, G., Koenitzer, J., Patel, H., Patel, P. P., Lancaster, J. R. Jr., Darley-Usmar, V. M., and Kraus, D. W.; Polarographic measurement of hydrogen sulfide production and consumption by mammalian tissues; Anal. Biochem.; (2005) 341: 40-51, the contents of which are incorporated by reference herein.

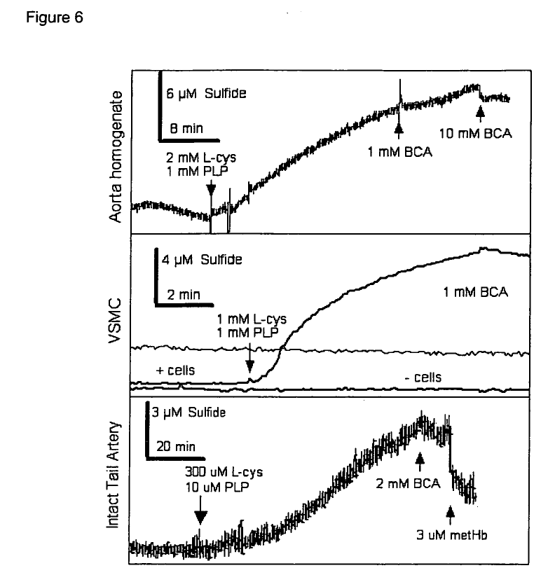

FIG. 6 illustrates measurement of real-time H₂S production in rat aorta homogenate (Aorta homogenate), cultured rat vascular smooth muscle cells (VSMC) and living rat tail artery (Intact Tail Artery). After supplying each of the samples with the amino acid L-cysteine and the vitamin pyridoxal L-phosphate (PLP), both substrate and cofactor respectively, for the enzyme in the blood vessels that is responsible for H₂S production, a rise in solution H₂S concentration is observed. To demonstrate that the H₂S is enzymatically produced the inhibitor beta-cyanoalanine, BCA, is added to limit any further H₂S production.

### EXAMPLE 4

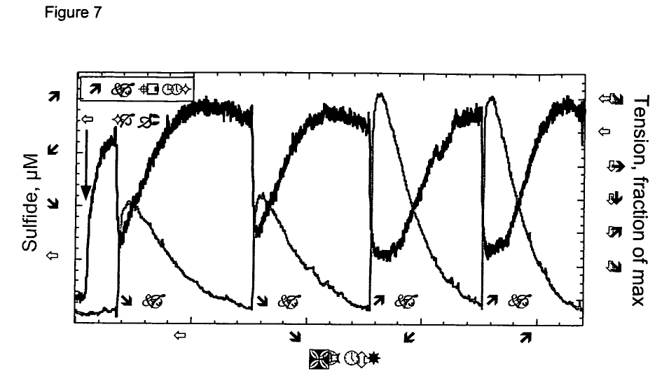

To demonstrate that H₂S can mediate vasorelaxation, segments of isolated rat aorta are placed in a vessel tension organ bath containing a physiological saline solution. Individual segments, 4 mm long and 1.5 mm in diameter, are tethered between the bath floor and a sensitive force transducer above the bath in order to measure any vasorelaxation as a decrease in tension. An electrochemical H₂S sensor (PHSS) is also immersed in the bath to simultaneously report the H₂S concentration. The aorta vessels are first contracted by adding 100 nM phenylephrine, PE, to the bath to stimulate physiological vessel tension. Once vessel tension is stabilized, sulfide (Na₂S) is injected to achieve hydrogen sulfide concentrations expected in vascular fluid and an immediate vasorelaxation event is recorded. As shown in FIG. 7, as the solution H₂S concentration (lower trace) decreases the vessels constrict back to the pre-H₂S level tension (upper trace). Measurement of such an acute response of blood vessels to H₂S concentration is only possible with the hydrogen sulfide detection apparatus comprising the PHSS.

While preferred embodiments of the foregoing invention have been set forth for purposes of illustration, the foregoing description should not be deemed a limitation of the invention herein. Accordingly, various modifications, adaptations and alternatives may occur to one skilled in the art without departing from the spirit and scope of the present invention.

What is claimed is:

1. An electrochemical sensor for measurement of hydrogen sulfide in a sample, comprising:
an electrolyte;
an enclosure containing the electrolyte and comprising a hydrogen sulfide permeable membrane; and
a working electrode and a reference electrode both at least partially disposed in the electrolyte.

2. The sensor of claim 1 wherein the working electrode comprises a noble metal and the reference electrode comprises a noble metal and a noble metal oxide.

3. The sensor of claim 1 wherein the working electrode comprises a noble metal selected from platinum, palladium, iridium, rhodium, ruthenium and osmium and the reference electrode comprises a noble metal selected from platinum, palladium, iridium, rhodium, ruthenium and osmium and an oxide of the selected noble metal.

4. The sensor of claim 1 wherein the working electrode comprises platinum and the reference electrode comprises platinum and platinum oxide.

5. The sensor of claim 1 wherein the hydrogen sulfide permeable membrane comprises a silicon polycarbonate material.

6. The sensor of claim 1 wherein the electrolyte comprises potassium ferricyanide, a sodium carbonate buffer solution having a pH of about 9 to about 13, propylene carbonate and potassium ferrocyanide.

7. The sensor of claim 1 wherein:
the electrolyte comprises a 0.1 M sodium carbonate buffer solution having a pH of about 10, 1% propylene carbonate and 0.05 M potassium ferrocyanide;
the hydrogen sulfide permeable membrane comprises silicon polycarbonate;
the working electrode comprises a noble metal selected from platinum, palladium, iridium, rhodium, ruthenium and osmium; and
the reference electrode comprises a metal selected from platinum, palladium, iridium, rhodium, ruthenium and osmium and an oxide of the selected metal.

8. The sensor of claim 1 wherein the sample comprises a gas, air, water, an aqueous solution or a biological solution.

9. A membrane for an electrochemical sensor for measurement of hydrogen sulfide in a sample, the membrane comprising silicon polycarbonate.

10. The membrane of claim 9 consisting of silicon polycarbonate.

11. A method of detecting hydrogen sulfide in a sample, comprising:
providing a sensor comprising a silicon polycarbonate gas permeable membrane, an electrolyte, a working electrode and a reference electrode, each electrode at least partially immersed in the electrolyte;
maintaining a fixed DC potential in the range of 0 mV to 1,000 mV between the working electrode and the reference electrode;
at least partially immersing the gas permeable membrane in the sample; and
detecting hydrogen sulfide in the sample.

12. The method of claim 11 wherein the DC potential is maintained in the range of about 100 mV to about 500 mV between the working electrode and the reference electrode.

13. The method of claim 11 wherein the DC potential is maintained at about 160 mV between the working electrode and the reference electrode.

14. The method of claim 11 wherein:
the electrolyte comprises a 0.1 M sodium carbonate buffer solution having a pH of 10, 1% propylene carbonate and 0.05 M potassium ferrocyanide;
the working electrode comprises a noble metal selected from platinum, palladium, iridium, rhodium, ruthenium and osmium;
the reference electrode comprises a noble metal selected from platinum, palladium, iridium, rhodium, ruthenium and osmium and a noble metal oxide of the selected metal; and
the DC potential is maintained in the range of about 100 mV to about 500 mV between the working electrode and the reference electrode.

15. The method of claim 11 wherein the step of detecting comprises quantitatively measuring the amount of hydrogen sulfide in the sample.

16. The method of claim 11 wherein the step of detecting comprises qualitatively indicating the presence or absence of a predetermined concentration of hydrogen sulfide in the sample.

17. The method of claim 11 wherein the sample is selected from a gas, air, water, an aqueous solution or a biological solution.
